(19) United States
(12) Patent Application Publication
(10) Pub. No.: US 2026/0034588 A1
(43) Pub. Date: Feb. 5, 2026

(54) DRILLING STOP

(71) Applicants: Anja HOFMANN, Hirschberg (DE); Andreas JAKUBOWSKI, Hirschberg (DE)

(72) Inventor: Andreas JAKUBOWSKI, Hirschberg (DE)

(21) Appl. No.: 18/998,766

(22) PCT Filed: Jul. 18, 2023
(86) PCT No.: PCT/EP2023/069916

§ 371 Date: Jan. 27, 2025

(30) Foreign Application Priority Data
Jul. 27, 2022 (DE) 102022118797.7

(51) Int. Cl. B23B 49/00

(52) U.S. Cl. CPC B23B 49/005

(57) ABSTRACT

A drill stop for a drilling tool with a shaft, wherein part of an outer surface has a stop-1 geometry, and stop-sleeve placed on the shaft, a stop-element with stop-3 geometry is provided, movable in axial direction and can be brought into engagement with the stop-1 geometry, the stop-element has locking-3 geometry and shaft has holding-1 geometry with respect to the axis of symmetry, wherein
a) the stop-sleeve has locking-2 geometry on the end face, which can be brought into contact with locking-3 geometry, wherein the stop-sleeve has holding-2 geometry, which can be brought into closure with the holding-1 geometry, or
b) a locking-part, which has holding-4 geometry, which can be brought into positive or non-positive engagement with holding-1 geometry, the locking-part having locking-4 geometry which can be brought into active contact with locking-3 geometry, or the stop-1 geometry is a recess and stop-3 geometry is a movable locking-pawl.

### FIELD OF THE INVENTION

The invention relates to a drill stop for a drilling tool with a shaft having an axis of symmetry and an outer surface, at least part of the outer surface having a stop-1 geometry, and with a stop-sleeve having a longitudinal axis, which can be placed on the shaft, wherein a stop-element with a central axis and a stop-3 geometry is provided, which is movable in the axial direction relative to the axis of symmetry and which can be brought into engagement with the stop-1 geometry for the purpose of axial positive or frictional locking-and against which the stop-sleeve can be placed at least indirectly in the axial direction for the purpose of limiting a drilling depth. Advantageously, a centric receptacle for a drilling tool can be provided on or in the shaft.

### BACKGROUND OF THE INVENTION

A drill stop is already known from DE 2 209 668 A. The drill stop has a stop-cylinder and a threaded section on the shaft, via which the position of the stop-cylinder on the shaft can be changed axially. A lock nut is also provided for fixing.

Similar drill stops are known from US 2010/0290850A1 and US 2011/0110740 A1.

DE 20 2009 017 801 U1 describes a countersink drill with a height-adjustable stop-sleeve.

### SUMMARY OF THE INVENTION

The invention is based on the task of designing and arranging a drill stop in such a way that simple disassembly and assembly are ensured.

The problem is solved in accordance with the invention in that the stop-element has a locking-3 geometry and in that the shaft has a holding-1 geometry with respect to the axis of symmetry, wherein
a) the stop-sleeve has a locking-2 geometry on the end face, which can be brought into active contact with the locking-3 geometry in order to fix the stop-element on the shaft in the circumferential direction relative to the axis of symmetry, wherein the stop-sleeve has a holding-2 geometry, which can be brought into a form or force closure with the holding-1 geometry of the shaft in the circumferential direction, or
b) a locking-part is provided with a holding-4 geometry which can be brought into a form or force closure in the circumferential direction with the holding-1 geometry of the shaft, the locking-part having a locking-4 geometry which can be brought into operative contact with the locking-3 geometry in order to fix the stop-element in the circumferential direction with respect to the axis of symmetry on the shaft, whereby the stop-sleeve can be placed against the locking-part in the axial direction, or that the stop-1 geometry is designed as a recess and the stop-3 geometry is designed as a movable pawl, whereby the pawl placed in the recess forms a form closure between the shaft and the stop-element in the axial direction. The holding-1 geometry can be a rotationally asymmetrical geometry with reference to the axis of symmetry of the shaft. The aforementioned active contact can be an engagement or a form closure. The aforementioned form or force closure can act or exist in the circumferential direction to the longitudinal axis in the stop-sleeve or in the circumferential direction to the axis of symmetry of the shaft. The stop-1 geometry designed as a recess and the stop-3 geometry designed as a movable pawl also form a form closure when the pawl is engaged, which prevents axial displacement of the stop-element. This force closure can be released by disengaging the pawl to move the stop-element. The recess can also be circumferential. One or more pawls can be provided around the circumference.

This ensures that by using the aforementioned locking-3 geometry of the stop-element together with the corresponding locking-2 geometry of the stop-sleeve or the locking-part, the stop-element can be locked in its desired position so that the stop-sleeve can be applied axially and its position can be determined. The aforementioned locking-effect is achieved by the additional holding-2 geometry of the sleeve or holding-4 geometry of the locking-part, so that the effective contact or form closure with the shaft is ultimately guaranteed. The stop-element can be adjusted axially for the purpose of setting the drilling depth or the stop-depth via the stop-1 geometry, via which the stop-element engages with the shaft. By attaching the stop-sleeve or the locking-part, a form or force closure can be created with the shaft so that the stop-element is ultimately fixed. If the form or force closure with the shaft is established via the locking-part, rotation of the stop-sleeve relative to the shaft and relative to the locking-part is possible. Relative movement between the stop-sleeve and the workpiece can therefore be reduced or avoided.

The task is also solved by a system consisting of a drilling stop and a drilling tool.

It can also be advantageous if the stop-sleeve has a contact element on the side facing the workpiece to be drilled, which can be rotated around the longitudinal axis relative to the stop-sleeve. The rotatably mounted contact element ensures that the work-piece to be drilled is protected, as a relative movement between the contact element and the workpiece is prevented when the stop-sleeve is placed on the workpiece, i.e. when the desired drilling depth is reached, so that only the part of the stop-sleeve facing the shaft continues to rotate and scratching of the workpiece surface is prevented.

It can also be advantageous if the axial form or force closure between the stop-element and the shaft can be established independently of the form or force closure between the stop-sleeve and the shaft acting in the circumferential direction or independently of the form or force closure between the locking-part and the shaft acting in the circumferential direction. This means that the stop-sleeve or the locking-part can be removed while the stop-element remains on the shaft. While the form or force closure between the stop-element and the shaft is a form or force closure in the axial direction to the axis of symmetry, the form or force closure between the stop-sleeve and the shaft or between the locking-part and the shaft is a form or force closure in the circumferential direction to the axis of symmetry. Only when the two form or force closures directed in different directions, i.e. axially and in the circumferential direction, are superimposed the stop-element is secured.

It can also be advantageous if the locking-part has a coupling geometry that can be brought into engagement with the locking-2 geometry of the stop-sleeve. When using a contact element, it can be advantageous if a corresponding form or force closure between the stop-sleeve and the locking-part also takes place in the circumferential direction. Protection of the workpiece surface is achieved by the above-mentioned rotatably mounted contact element provided at the end when the stop-sleeve is rotating.

It may advantageously be provided that the stop-element has a clamping torque Mk with respect to the center axis, Mk>=1 Nm or 0.1 Nm. If the stop-element has a clamping torque with reference to the stop-1 geometry on the shaft or the stop-3 geometry of the stop-element, independent movement of the stop-element on the shaft is prevented by drilling activities even without a stop-sleeve or locking-part attached. In this case, the shaft with the stop-element on it could be used for drilling, even if the stop-sleeve is not attached and therefore cannot exert any locking-effect on the stop-element.

It can be of particular importance for the present invention if the stop-3 geometry and the stop-1 geometry are designed as a right-hand or left-hand thread. If a thread is used as stop-1 geometry, the axial position of the stop-element on the shaft can be easily adjusted by rotating it about the axis of symmetry. When using a left-hand thread, it is achieved that, in the event of the stop-sleeve being rotated due to contact with a work-piece surface when no contact element is present, the stop-element is at most adjusted downwards, thus resulting in a reduction of the drilling depth or stop-depth. This prevents an unintentional increase in the drilling depth.

In connection with the design and arrangement according to the invention, it can be advantageous if the stop-sleeve and/or the stop-element and/or the locking-part are magnetically designed or have a magnet, so that a holding-force acting in the axial direction is formed between the stop-sleeve and the stop-element or between the stop-sleeve and the locking-part or between the stop-element and the locking-part. By using corresponding magnets or by using a corresponding magnetism, axial retention of the locking-sleeve on the stop-element and axial retention of the locking-part on the stop-element and axial retention of the stop-sleeve on the locking-part can be ensured. The counterpart to the magnet is designed to be ferromagnetic. To adjust the stop-element without tools, only the stop-sleeve or the locking-part needs to be released axially without tools against the magnetic force and placed axially without tools to secure it by utilizing the magnetic force.

It can also be advantageous if the holding-1 geometry, the holding-2 geometry, the holding-4 geometry, the locking-2 geometry, the locking-3 geometry, the locking-4 geometry and/or the coupling geometry are rotationally asymmetrical or designed as a 4-, 6-or 8-edge contour or have a star-shaped contour. The use of standard hexagonal profiles makes production simple and cost-effective. Simple handling is also ensured with regard to the axial assembly or disassembly of the various holding-geometries of the stop-element, stop-sleeve or locking-part and shaft.

Furthermore, it can be advantageous if a machine mount is provided for clamping in a chuck of a drilling machine, whereby wherein the machine mount is in a form or force closure connection with the drill and/or the shaft or can be brought into a form or force closure connection. The integral machine mount on the shaft ensures use in commercially available drill chucks by inserting and/or clamping. The machine mount can therefore also be part of the drill. In this case, the drill stop is placed or pushed onto the drill. In addition, it can be advantageous if the active contact
between the locking-3 geometry of the stop-element and the locking-2 geometry of the stop-sleeve and/or
between the locking-3 geometry of the stop-element and the locking-4 geometry of the locking-part and/or
between the holding-1 geometry of the shaft and the holding-2 geometry of the stop-sleeve and/or
between the holding-1 geometry of the shaft and the holding-4 geometry of the locking-part and/or
between the locking-2 geometry of the stop-sleeve and the coupling geometry of the locking-part
can be established without tools and/or by axially sliding one on top of the other or one inside the other. This allows the stop-or drilling depth to be set and secured quickly and easily.

It can also be advantageous if a scale is provided on the shaft, by means of which a stop-depth of the stop-sleeve relative to the drilling tool can be determined. The scale on the shaft ensures simple and quick adjustment of the stop-element, and therefore simple adjustment of the stop-depth T or the drilling depth.

### BRIEF DESCRIPTION OF THE DRAWINGS

Further advantages and details of the invention are explained in the patent claims and in the description and shown in the figures. It shows:

FIG. 1a a side view of the drill stop;

FIG. 1b a view from below;

FIG. 2a a stop-element viewed from above;

FIG. 2b a side view of a stop-element;

FIG. 3a side view of a stop-sleeve;

FIG. 3b top view of the stop-sleeve;

FIG. 4a a side view of a locking-part;

FIG. 4b top view of the locking-part;

FIG. 4c the locking-part viewed from below;

FIG. 5 the drill stop according to FIG. 1a with locking-part;

FIG. 6 the stop-sleeve shown in FIG. 3b without locking-geometry;

FIG. 7 the locking-part in the view according to FIG. 4c without coupling geometry;

FIG. 8a a further example of the locking-part;

FIG. 8b the shaft for the design example shown in FIG. 8a;

FIG. 8c the stop-sleeve for the design example shown in FIG. 8a.

### DETAILED DESCRIPTION OF THE INVENTION

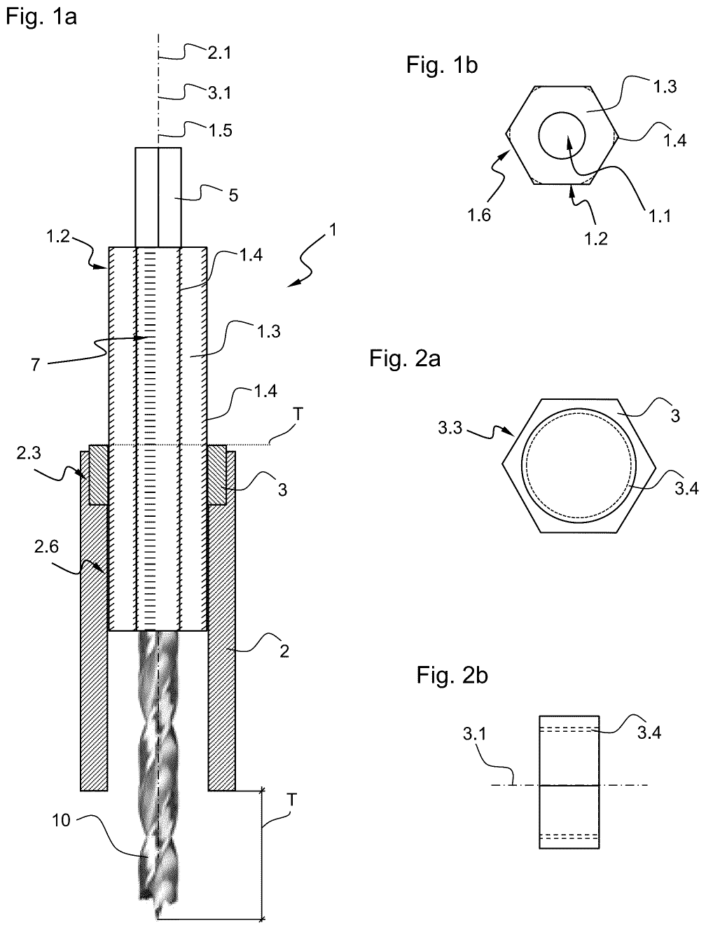

A drill stop 1 as shown in FIG. 1a has a shaft 1.3 with a machine mount 5 arranged at the end for a drill chuck not shown. A drilling tool 10 is provided opposite, which is attached via a mount 1.1 as shown in FIG. 1b. The shaft 1.3 also has a stop-1 geometry 1.4 designed as an external thread and an outer surface 1.2 with a hexagonal holding-1 geometry 1.6. As can be seen in FIG. 1b, the external thread 1.4 is provided exclusively in the edge areas of the hexagonal outer surface 1.2.

A stop-element 3 is placed on the shaft via the external thread 1.4, which has a hexagonal locking-3 geometry 3.3 as shown in FIG. 2a. The stop-3 geometry 3.4 shown in FIG. 2a, which is designed as an internal thread, engages in the external thread 1.4 of the shaft. In this way, the stop-element can be moved or adjusted axially on the shaft in the axial direction to the axis of symmetry 1.5.

In addition, a stop-sleeve 2 sits on the shaft. The stop-sleeve 2 has both a hexagonal locking-2 geometry 2.3, with which it sits on the hexagonal locking-3 geometry 3.3 of the stop-element 3, and a hexagonal holding-2 geometry 2.6, with which it sits on the corresponding hexagonal holding-1 geometry 1.6 of the shaft. This results in a form closure between the outer surface 1.2 of the shaft 1.3 and the stop-sleeve 2 in relation to the circumferential direction of the axis of symmetry 1.5, as well as a correspondingly directed form closure between the stop-sleeve 2 and the stop-element 3, so that the stop-element 3 is ultimately fixed in place when the stop-sleeve is fitted.

The aforementioned stop-3 geometry, i.e. the internal thread of the stop-element 3, can be seen in FIG. 2b in the side view together with the center axis 3.1 of the stop-element 3.

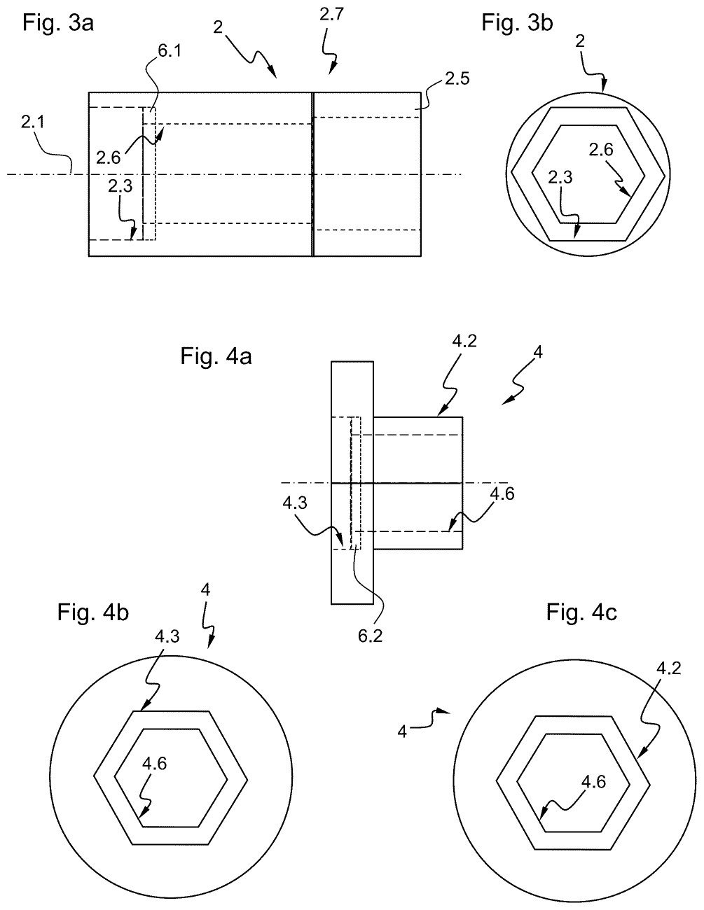

The stop-sleeve 2 shown in FIG. 3a has the above-mentioned geometries at its left end, i.e. the locking-2 geometry 2.3 and the holding-2 geometry 2.6. The stop-sleeve 2 is fitted and guided with its longitudinal axis 2.1 coaxial to the axis of symmetry 1.5 onto the corresponding hexagonal shaft via the holding-2 geometry 2.6. The locking-2 geometry 2.3 engages with the stop-element and thus fixes it in the circumferential direction. The two geometries 2.3 and 2.6 can be seen in the top view in FIG. 3b. The outer side of the stop-sleeve is also round.

At the end, the stop-sleeve 2 has a contact element 2.5, which is rotatably mounted and can remain fixed or stationary when the stop-sleeve 2 rotates.

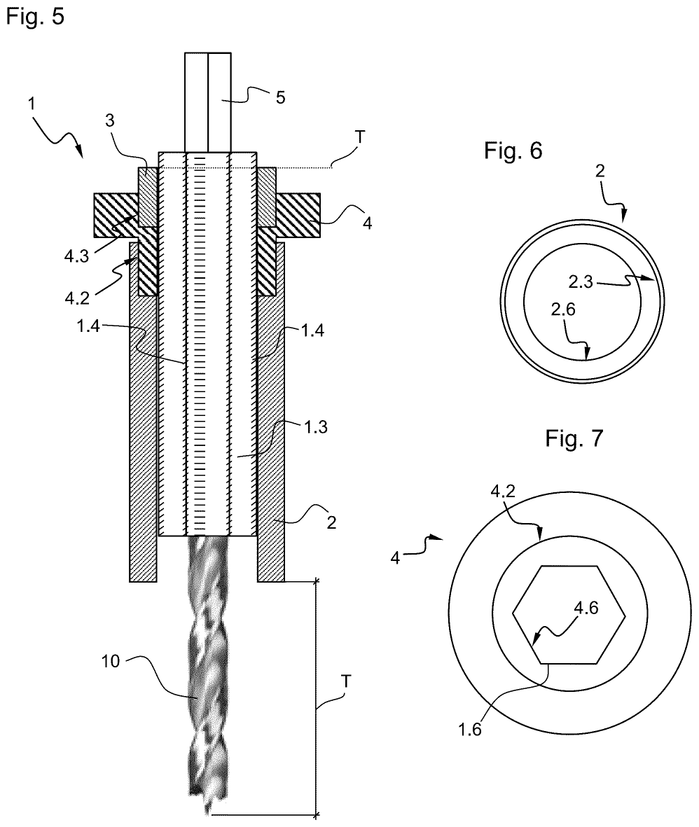

So that the drill stop 1 can also be used for free drilling without stop-sleeve 2 and so that the stop-element 3 nevertheless remains fixed when the stop-sleeve 2 is removed, a locking-part 4 is provided as shown in FIGS. 4a to 4c. According to FIG. 4a, the locking-part 4 has a locking-4 geometry 4.3 on the left-hand side, via which it engages with the stop-element 3 or its locking-3 geometry 3.3. In addition, the locking-part 4 has the holding-4 geometry 4.6, via which it engages on the holding-1 geometry 1.6 of the shaft 1.3. This ensures the locking-effect of the locking-part 4 with respect to the stop-element 3 when the locking-part 4 is in place. The two previously mentioned geometries 4.3, 4.6 can be seen in the side view according to 4b. In the side view from below according to FIG. 4c, the holding-4 geometry 4.6 can also be seen, as well as a coupling geometry 4.2. The coupling geometry 4.2 in turn serves to hold the stop-sleeve 2 via its locking-2 geometry 2.3 as shown in FIG. 5.

According to embodiment example FIG. 5, the stop-element 3 is secured against rotation via the locking-part 4. The locking-part 4 is in turn secured against rotation via its holding-4 geometry 4.6 on the holding-1 geometry 1.6 of the shaft, so that the stop-element 3 is completely locked. The stop-sleeve 2 in turn sits on the locking-part 4. This can be either via the coupling geometry 4.2 according to FIG. 4a, on which the stop-sleeve 2 sits with its locking-2 geometry 2.3. Alternatively, as shown in FIGS. 6, 7, a corresponding locking-geometry and coupling geometry can be dispensed with so that the stop-sleeve 2 sits rotatably on the locking-part 4.

The shaft 1.3 also has a scale 7 that is designed for the length of the drilling tool 10 or the length of the stop-sleeve 2 in combination with the stop-element 3. The user can use the scale 7 to easily read off the drilling depth T or set the stop-depth or drilling depth T beyond which the drilling tool protrudes beyond the stop-sleeve 2. The same applies to the design example in FIG. 5 when using the locking-part 4.

According to FIG. 2a, the stop-sleeve 2 has a magnet 6.1, which limits the locking-2 geometry 2.3 downwards. This ensures that the stop-sleeve 2 is held on the stop-element 3 on the one hand and on the locking-part 4 on the other. Both are made of magnetic iron. This magnetic force serves to hold the stop-sleeve 2 axially after it has been placed on the shaft 1.3. Furthermore, the locking-part 4 according to FIG. 4a also has a magnet 6.2, which also serves to hold the locking-part 4 axially on the stop-element 3.

According to embodiment example FIG. 6, neither the holding-2 geometry 2.6 nor the locking-2 geometry 2.3 or the corresponding hexagonal geometries are present. The geometries are simply round for the purpose of rotating the stop-sleeve 2 relative to the shaft 1.3 and relative to the locking-part 4.

The same applies to the original coupling geometry 4.2 as shown in FIG. 7, which is now round for the purpose of rotating the stop-sleeve 2. The holding-4 geometry 4.6 or the corresponding hexagon is still present for the purpose of operative connection with the shaft 1.3 or the holding-1 geometry 1.6 in hexagonal form.

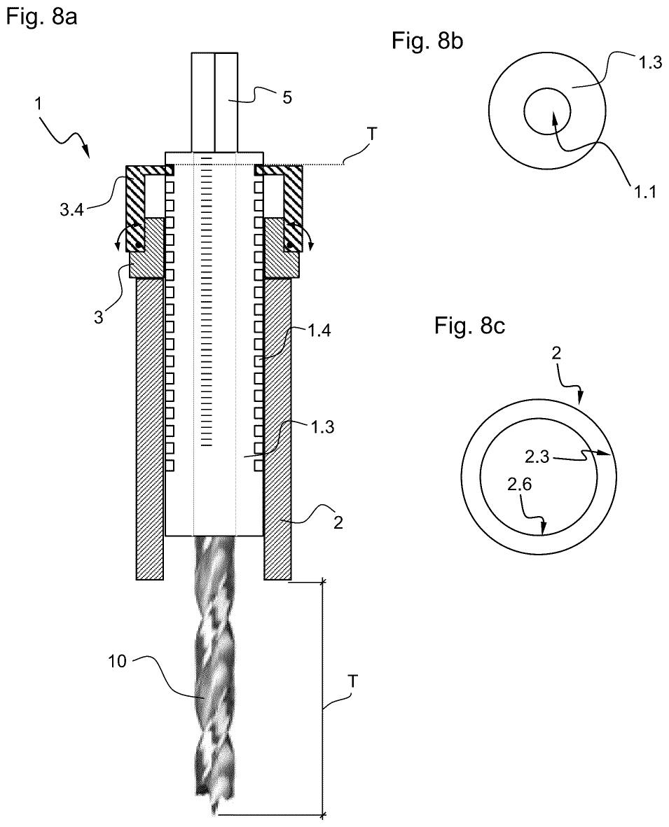

According to embodiment example FIG. 8a, the stop-1 geometry 1.4 is designed as a recess and the stop-3 geometry 3.4 as a movable or pivotable pawl. The pawl 3.4 placed in the recess forms a form closure between the shaft 1.3 and the stop-element 3 in the axial direction. This form closure can be released to displace the stop-element 3, for example by spring-loaded disengagement of the pawl 3.4 radially outwards. The recesses are provided opposite each other on the shaft 1.3. The axial grid of the recesses determines the stop-depth grid. Only one pawl 3.4 can also be provided. Only one circumferential recess can also be provided on the shaft 1.3. In principle, it is also possible to rotate the stop-element 3 and strike the stop-sleeve 2 against the respective pawl 3.4. This would be accompanied by a locking-effect of the pawl 3.4 to prevent disengagement.

The shaft 1.3 can be round as shown in FIG. 8b. The form closure is achieved via the pawl 3.4. The stop-sleeve 2 according to FIG. 8c can also be cylindrical, i.e. round on the inside.

### List of Reference Symbols

1 drill stop
1.1 mount
1.2 outer surface
1.3 shaft
1.4 stop-1 geometry, external thread, left-hand thread, recess
1.5 symmetry axis
1.6 hold-1 geometry
2 stop-sleeve
2.1 longitudinal axis
2.3 lock-2 geometry
2.5 system element
2.6 hold-2 geometry
2.7 workpiece-facing side
3 stop-element
3.1 centerline
3.3 lock-3 geometry
3.4 stop-3 geometry, internal thread, left-hand thread,
4 locking-part
4.3 lock-4 geometry
4.6 hold-4 geometry
4.2 coupling geometry
5 machine mount
6.1 magnet
6.2 magnet
7 scale
10 drilling tool, drill bit
T stop-depth, drilling depth

1. A drilling stop for a drilling tool; comprising:
a shaft having an axis of symmetry and an outer surface, wherein at least a part of the outer surface has a stop-1 geometry, and with a stop-sleeve having a longitudinal axis, which can be placed and moved axially on the shaft, wherein as an additional component a stop-element with a center axis, a locking-3 geometry and a stop-3 geometry is provided, which can be moved in the axial direction relative to the axis of symmetry on the shaft by axial positive or frictional locking brought into engagement with the stop-1 geometry and can be adjusted in the axial direction independently of the stop sleeve and against which the stop-sleeve can be placed at least indirectly in the axial direction for the purpose of limiting a drilling depth T,
wherein the stop-element has a locking-3 geometry and that the shaft has a holding-1 geometry with respect to the axis of symmetry, wherein
a) the stop-sleeve has a locking-2 geometry on the end face, which can be brought into operative contact with the locking-3 geometry in order to fix the stop-element in the circumferential direction relative to the axis of symmetry, the stop-sleeve having a holding-2 geometry, which can be brought into a form or force closure in the circumferential direction with the holding-1 geometry of the shaft, or
b) as an additional component a locking-part is provided which has a holding-4 geometry which can be brought into a form or force closure in the circumferential direction with the holding-1 geometry of the shaft, wherein the locking-part has a locking-4 geometry which can be brought into operative contact with the locking-3 geometry in order to fix the stop-element in the circumferential direction relative to the axis of symmetry on the shaft, wherein the stop-sleeve can be placed against the locking-part in the axial direction, or
c) wherein the stop-1 geometry is designed as a recess and the stop-3 geometry is designed as a movable pawl, the pawl placed in the recess forming a form closure between the shaft and the stop-element in the axial direction, whereby the stop-sleeve is mounted five-point and can be moved axially.

2. The drilling stop according to claim 1, wherein the stop-sleeve has, on the side facing a workpiece to be drilled, a contact element which is rotatable relative to the stop-sleeve about the longitudinal axis.

3. The drilling stop according to claim 1, wherein the axial form or force closure between the stop-element and the shaft can be established independently of the form or force closure acting in the circumferential direction between the stop-sleeve and the shaft or independently of the form or force closure acting in the circumferential direction between the locking-part and the shaft.

4. The drilling stop according to claim 1, wherein the locking-part has a coupling geometry which can be brought into engagement with the locking-2 geometry of the stop-sleeve.

5. The drilling stop according to claim 1, wherein the stop-element has a clamping torque Mk with respect to the center axis, Mk>=1 Nm or 0.1 Nm.

6. The drilling stop according to claim 1, wherein the stop-3 geometry and the stop-1 geometry are designed as right-hand or left-hand threads.

7. The drilling stop according to claim 1, wherein the stop-sleeve and/or the stop-element and/or the locking-part are magnetically designed or have a magnet, so that a holding-force acting in the axial direction is formed between the stop-sleeve and the stop-element or between the stop-sleeve and the locking-part or between the stop-element and the locking-part.

8. The drilling stop according to claim 1, wherein the holding-1 geometry, the holding-2 geometry, the holding-4 geometry, the locking-2 geometry, the locking-3 geometry, the locking-4 geometry and/or the coupling geometry are rotationally asymmetrical or designed as a 4-, 6-or 8-edge contour or have a star-shaped contour.

9. The drilling stop according to claim 1, wherein a machine mount is provided for clamping in a chuck of a drilling machine, wherein the machine mount is or can be brought into a form or force closure connection with the drill and/or the shaft or can be brought into a form or force closure connection.

10. The drilling stop according to claim 1, wherein the effective contact
between the locking-3 geometry of the stop-element and the locking-2 geometry of the stop-sleeve and/or
between the locking-3 geometry of the stop-element and the locking-4 geometry of the locking-part and/or
between the holding-1 geometry of the shaft and the holding-2 geometry of the stop-sleeve and/or
between the holding-1 geometry of the shaft and the holding-4 geometry of the locking-part and/or
between the locking-2 geometry of the stop-sleeve and the coupling geometry of the locking-part
can be established without tools and/or by axial sliding on top of or into one another.

11. A system comprising a drilling stop according to claim 1 and a drilling tool.

12. The system according to claim 11, wherein a scale is provided on the shaft, by which a stop-depth T of the stop-sleeve relative to the drilling tool can be determined.

13. The drilling stop according to claim 2, wherein the axial form or force closure between the stop-element and the shaft can be established independently of the form or force closure acting in the circumferential direction between the stop-sleeve and the shaft or independently of the form or force closure acting in the circumferential direction between the locking-part and the shaft, and wherein the locking-part has a coupling geometry which can be brought into engagement with the locking-2 geometry of the stop-sleeve.

14. The drilling stop according to claim 13, wherein the stop-element has a clamping torque Mk with respect to the center axis, Mk>=1 Nm or 0.1 Nm, and wherein the stop-3 geometry and the stop-1 geometry are designed as right-hand or left-hand threads.

15. The drilling stop according to claim 14, wherein the stop-sleeve and/or the stop-element and/or the locking-part are magnetically designed or have a magnet, so that a holding-force acting in the axial direction is formed between the stop-sleeve and the stop-element or between the stop-sleeve and the locking-part or between the stop-element and the locking-part, and wherein the holding-1 geometry, the holding-2 geometry, the holding-4 geometry, the locking-2 geometry, the locking-3 geometry, the locking-4 geometry and/or the coupling geometry are rotationally asymmetrical or designed as a 4-, 6-or 8-edge contour or have a star-shaped contour.

16. The drilling stop according to claim 15, wherein a machine mount is provided for clamping in a chuck of a drilling machine, wherein the machine mount is or can be brought into a form or force closure connection with the drill and/or the shaft or can be brought into a form or force closure connection, and wherein the effective contact
between the locking-3 geometry of the stop-element and the locking-2 geometry of the stop-sleeve and/or
between the locking-3 geometry of the stop-element and the locking-4 geometry of the locking-part and/or
between the holding-1 geometry of the shaft and the holding-2 geometry of the stop-sleeve and/or
between the holding-1 geometry of the shaft and the holding-4 geometry of the locking-part and/or
between the locking-2 geometry of the stop-sleeve and the coupling geometry of the locking-part
can be established without tools and/or by axial sliding on top of or into one another.

17. A system comprising a drilling stop according to claim 16 and a drilling tool.

18. The system according to claim 11, wherein a scale is provided on the shaft, by which a stop-depth T of the stop-sleeve relative to the drilling tool can be determined.
